(19) United States
(12) Patent Application Publication
(10) Pub. No.: US 2018/0309843 A1
(43) Pub. Date: Oct. 25, 2018

(54) Managing Content of Virtual Containers

(71) Applicant: Poshmark, Inc., Redwood City, CA (US)

(72) Inventors: Manish Chandra, San Jose, CA (US); Gautam Golwala, Sunnyvale, CA (US); John Michael McDonald, Burlingame, CA (US); Jennifer Quoc Kim, Saratoga, CA (US)

(21) Appl. No.: 15/963,045

(22) Filed: Apr. 25, 2018

Related U.S. Application Data
(60) Provisional application No. 62/489,920, filed on Apr. 25, 2017.

(51) Int. Cl. H04L 29/08; G06F 17/30

(52) U.S. Cl. CPC H04L 67/306; H04L 67/20; G06F 17/30864

(57) ABSTRACT

Systems and methods for providing multiple users with access to a virtual container are described. In an example implementation, a method includes generating a virtual container, maintaining the virtual container by managing the contents of the virtual container and managing a state of the virtual container, determining a recommendation of a virtual item based on criteria associated with a first remote network client, sending to a second remote network client a control signal representing the recommendation of the virtual item, adding information representing the virtual item to the contents of the virtual container, sending to the first remote network client, a control signal representing that the virtual item has been added to the contents of the virtual container, updating the contents of the virtual container, updating the state of the virtual container to a locked state, and publishing the contents of the virtual container.

### CROSS-REFERENCE TO RELATED APPLICATIONS

The present application claims the benefit under 35 U.S.C. § 119(e) of U.S. Provisional Patent Application Ser. No. 62/489,920, entitled “Personal Styling using Data and Artificial Intelligence,” filed on Apr. 25, 2017, the entire contents of which are incorporated herein by reference.

### TECHNICAL FIELD

The present disclosure relates to managing content of virtual containers.

### BACKGROUND

The internet has expanded the processes by which users of various computing devices may collaborate and exchange information. By taking advantage of cloud-based internet applications, multiple disparate users can work together and collaborate on shared content. By allowing all of these various remote users to collaborate and work with shared content, the exchange of information and ideas can occur over vast distances in almost real-time. However, a variety of issues concerning access, security, levels of permission, and privacy arise when shared content is accessible to multiple remote user over the cloud-based internet applications. It would be desirable to address these issues.

### SUMMARY

One general aspect of the subject matter in this disclosure is a computer-implemented method for providing multiple users with access to a digital container, the method including the steps of: generating by a server, a virtual container accessible by a plurality of remote network clients, where the virtual container is a structured virtual representation of a box stored in an area of memory accessible via a network and protected by permissions; maintaining the virtual container, where maintaining the virtual container includes managing contents of the virtual container and managing a state of the virtual container; determining a recommendation of a virtual item from a plurality of virtual items responsive to one or more attributes associated with a first remote network client of the plurality of remote network clients; sending over the network to a second remote network client of the plurality of remote network clients, a control signal representing the recommendation of the virtual item; adding information representing the virtual item to the contents of the virtual container responsive to receiving a control signal over the network from the second remote network client representing an indication to add the virtual item to the virtual container; sending over the network to the first remote network client, a control signal representing that the information representing the virtual item has been added to the contents of the virtual container; updating the contents of the virtual container responsive to receiving a control signal over the network from the first remote network client representing a revision to the contents of the virtual container; updating the state of the virtual container to a locked state; and publishing the contents of the virtual container in the locked state to the plurality of remote network clients. Other embodiments of this aspect include corresponding computer systems, apparatus, and computer programs recorded on one or more computer storage devices, each configured to perform the actions of the method.

Implementations may include one or more of the following features. The method where publishing the contents of the virtual container in the locked state further includes: granting read-only access to the contents of the virtual container for one or more of the plurality of remote network responsive to receiving a control signal over the network from the one or more of the plurality of remote network clients requesting to read the contents of the virtual container. The method further including: directing a third party server to take further action responsive to the virtual container being updated to the locked state. The method further including: generating the virtual container by the server responsive to receiving a control signal over the network from the first remote network client representing a request for virtual items to be added to the virtual container. The method further including: determining by the server, a match between the first remote network client and the second remote network client, the match being determined using a scoring algorithm that matches at least one attribute concerning the first remote network client with at least one attribute concerning the second remote network client; and sending notifications to the first remote network client and the second remote network client responsive to the match. The method where the attribute concerning the first remote network client includes profile information associated with a user of the first remote network client and the attribute concerning the second remote network client includes one or more of a responsiveness of the second remote network client, a type of physical item available from the second remote network client, and a success rate of previous interactions of the second remote network client. The method where determining the recommendation of the virtual item further includes: comparing the one or more attributes associated with the first remote network client with item characteristics associated with the plurality of virtual items; and identifying the virtual item that exceeds a threshold of similarities with the one or more attributes of the first remote network client, responsive to the comparison. The method where updating the contents of the virtual container further includes one of adding information representing an additional virtual item and removing information representing a previously added virtual item from the contents of the virtual container. The method where publishing the contents of the virtual container further includes: generating a graphical user interface that displays a graphical representations of the contents of the virtual container; and sending the graphical user interface over the network to a remote network client of the plurality of remote network clients responsive to receiving a control signal over the network from the remote network client representing a request to view the contents of the virtual container. Implementations of the described techniques may include hardware, a method or process, or computer software on a computer-accessible medium

One general aspect includes a computer-implemented method, for providing multiple users with access to a digital container, the method including the steps of: maintaining by a server, a virtual container accessible by a plurality of remote network clients, where the virtual container is a structured virtual representation of a box stored in an area of memory accessible via a network and protected by permissions and where maintaining the virtual container includes managing contents of the virtual container and managing a state of the virtual container; determining by the server, a match between a first remote network client and a second remote network client, the match being determined using a scoring algorithm that matches at least one attribute concerning the first remote network client with at least one attribute concerning the second remote network client; sending a notification to the first remote network client and a notification to the second remote network client responsive to the match; adding information representing a virtual item to the contents of the virtual container responsive to receiving a control signal over the network from the second remote network client representing an indication to add the virtual item to the virtual container; and sending over the network to the first remote network client, a control signal representing that the information representing the virtual item has been added to the contents of the virtual container. Other embodiments of this aspect include corresponding computer systems, apparatus, and computer programs recorded on one or more computer storage devices, each configured to perform the actions of the methods.

Implementations may include one or more of the following features. The method where the attribute concerning the second remote network client includes one or more of a responsiveness of the second remote network client, a type of physical item available from the second remote network client, and a success rate of previous interactions of the second remote network client. The method where the attribute concerning the first remote network client includes profile information associated with a user of the first remote network client. The method where the information is first information and the virtual item is a first virtual item, the method further including: adding second information representing a second virtual item to the contents of the virtual container responsive to receiving a control signal over the network from the first remote network client representing an indication to add the second virtual item to the virtual container. The method further including: updating the state of the virtual container to a locked state responsive to receiving a control signal over the network from the first remote network client representing a request to lock the virtual container; and publishing the contents of the virtual container in the locked state to the plurality of remote network clients. The method where publishing the contents of the virtual container further includes: generating a graphical user interface that displays a graphical representations of the contents of the virtual container; and sending the graphical user interface over the network to a remote network client of the plurality of remote network clients responsive to receiving a control signal over the network from the remote network client representing a request to view the contents of the virtual container. The method where publishing the contents of the virtual container in the locked state further includes: granting read only access for one or more of the plurality of remote network clients responsive to receiving a control signal over the network from the one or more of the plurality of remote network clients requesting to read the contents of the virtual container. The method further including: directing a third party server to take further action responsive to the virtual container being updated to the locked state. Implementations of the described techniques may include hardware, a method or process, or computer software on a computer-accessible medium.

The above described general aspects and implementations can also be in the form of one or more servers and/or computer readable media.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for managing content of virtual containers according to one embodiment.

FIG. 2 is a block diagram illustrating an example computer system for managing content of virtual containers according to one embodiment.

FIG. 3 is a flow chart of an example block diagram illustrating an example method for managing content of virtual containers according to one embodiment.

FIGS. 4A and 4B are flowcharts of an example method for managing content of virtual containers according to one embodiment.

FIG. 5 is a flowchart of an example method for managing content of virtual containers according to one embodiment.

FIG. 6 is a graphical representation of a graphical user interface for managing content of virtual containers according to one embodiment.

FIG. 7 is a graphical representation of a graphical user interface for managing content of virtual containers according to one embodiment.

FIGS. 8A and 8B are graphical representations of a graphical user interface for managing content of virtual containers according to one embodiment.

FIG. 9 is a graphical representation of a graphical user interface for managing content of virtual containers according to one embodiment.

The Figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

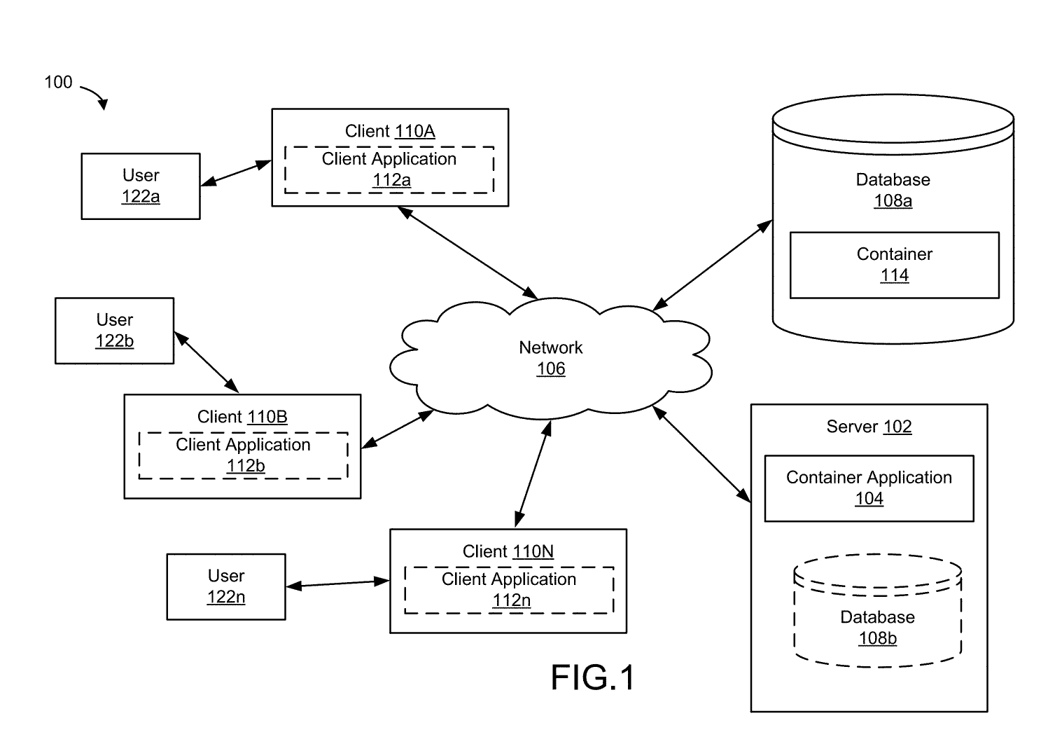

The technology described herein provides a system and methods for managing content of virtual containers. FIG. 1 is a block diagram illustrating an example system for managing content of virtual containers according to one implementation. The illustrated system 100 includes clients 110a . . . 110n (also referred to individually and collectively as 110), databases 108a and 108b (also referred to individually and collectively as 108), and server 102, which are communicatively coupled via a network 106 for interaction with one another. For example, the clients 110a . . . 110n may be respectively coupled to the network 106 via signal lines and may be accessed by users 122a . . . 122n (also referred to individually and collectively as 122). Database 108a may be coupled to the network 106 via signal lines. The server 102 may be coupled to the network 106 via signal lines and may send and receive data via the network 106 to the client 110 and/or the database 108a. The use of the nomenclature “a” and “n” in the reference numbers indicates that any number of those elements having that nomenclature may be included in the system 100.

The network 106 may include any number of networks and/or network types. For example, the network 106 may include, but is not limited to, one or more wide area networks (WANs) (e.g., the Internet), local area networks (LANs), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The clients 110a . . . 110n (also referred to individually and collectively as 110) are computing devices having data processing and communication capabilities. For instance, a client 110 may include a processor (e.g., virtual, physical, etc.), a memory, a power source, a network interface, and/or other software and/or hardware components, such as front and/or rear facing cameras, display, graphics processor, wireless transceivers, keyboard, camera, sensors, firmware, operating systems, drivers, various physical connection interfaces (e.g., USB, HDMI, etc.). The clients 110a . . . 110n may couple to and communicate with one another and the other entities of the system 100 via the network 106 using a wireless and/or wired connection. While three or more clients 110 are depicted in FIG. 1, the system 100 may include any number of clients 110. In addition, the clients 110a . . . 110n may be instantiated using the same or different types of computing devices. Example clients 110 may include, but are not limited to, mobile phones (e.g., feature phones, smart phones, etc.), tablets, laptops, desktops, netbooks, smart TVs, set-top boxes, media streaming devices, portable media players, navigation devices, personal digital assistants, wearable devices, etc.

As depicted in FIG. 1, one or more of the clients 110a . . . 110n may include a client application 112a . . . 112n (also referred to individually and collectively as 112). The client application 112 may be capable of receiving information (such as requests, profile information, user data, item information, etc.) and sending that information to the server 102 via the network 106. The client application 112 may also be capable of receiving control signals via the network 106 from the server 102 that cause the client application 112 to present a graphical user interface (“GUI”) on a display of the client 110. In some implementations, the client application 112 may include the drivers and other software to arrange the data received from the server 102 into the GUI to present on the display.

The database 108 may include one or more applications for storing and managing content in a virtual container 114. The database 108 may include memory and/or storage for storing the content of virtual containers 114. In some implementations, the database 108 may store content to/from one or more clients 110 represented as virtual containers 114 that the one or more clients 110 may add/remove information associated with virtual items from. In some implementations, the database 108 may represent one or more virtual containers 114 as structured content. In some implementations, the virtual container 114 may be represented as an entry in a structured list, such as a set of records, rows, and columns or other formats in the database 108. The database 108 may be capable of accessing, reading, and or writing content from the structured list (or other format) to/from a requesting device (such as the client 110 and/or the server 102). While database 108a is shown separate from the server 102 and accessible via the network 106, in some implementations, the database 108b may reside on the server 102 and one or more virtual containers 114 stored within database 108b may be directly accessible to the server 102. It should be understood that the database 108 is only one implementation in which virtual containers 114 may be stored. Other options, in other implementations are also contemplated, such as a linked list, separate files, etc.

The server 102 may include one or more applications and/or third party clients having data processing, storing, and communication capabilities. For example, the server 102 may include one or more hardware servers, server arrays, storage devices and/or systems, etc., and/or may be centralized or distributed/cloud-based. In some implementations, the server 102 may include one or more virtual servers, which operate in a host server environment and access the physical hardware of the host server including, for example, a processor, memory, storage, network interfaces, etc., via an abstraction layer (e.g., a virtual machine manager).

The server 102 may include software applications operable by one or more computer processors of the server 102 to provide various computing functionalities, services, and/or resources, and to send data to and receive data from the clients 110. For example, the software applications may provide functionality for internet searching; social networking; web-based email; blogging; micro-blogging; photo management; video, music and multimedia hosting, distribution, and sharing; business services; news and media distribution; user account management; or any combination of the foregoing services. It should be understood that the server 102 is not limited to providing the above-noted services and may include other network-accessible services.

In some implementations, the server 102 may also include a container application 104. The container application 104 may include software and/or logic to manage the contents of a virtual container 114. For example, the container application 104 may be configured to receive data from one or more clients 110 related to items associated with a virtual container 114 and allow one or more of the clients 110 to add, remove, and/or update the contents of the virtual container 114. In further implementations, the container application 104 may be capable of matching clients 110 or providing recommendations of items for a virtual container 114. The container application 104 may be capable of sending and receiving control signals representing commands for managing content of a virtual container 114 to a database 108 via the network 106.

It should be understood that the system 100 illustrated in FIG. 1 is provided by way of example, and that a variety of different system environments and configurations are contemplated and are within the scope of the present disclosure. For instance, various functionality may be moved from a server to a client, or vice versa, and some implementations may include additional or fewer clients, services, and/or networks, and may implement various functionality client or server-side. Further, various entities of the system 100 may be integrated into a single client or server, and/or be distributed across multiple clients and/or servers, etc.

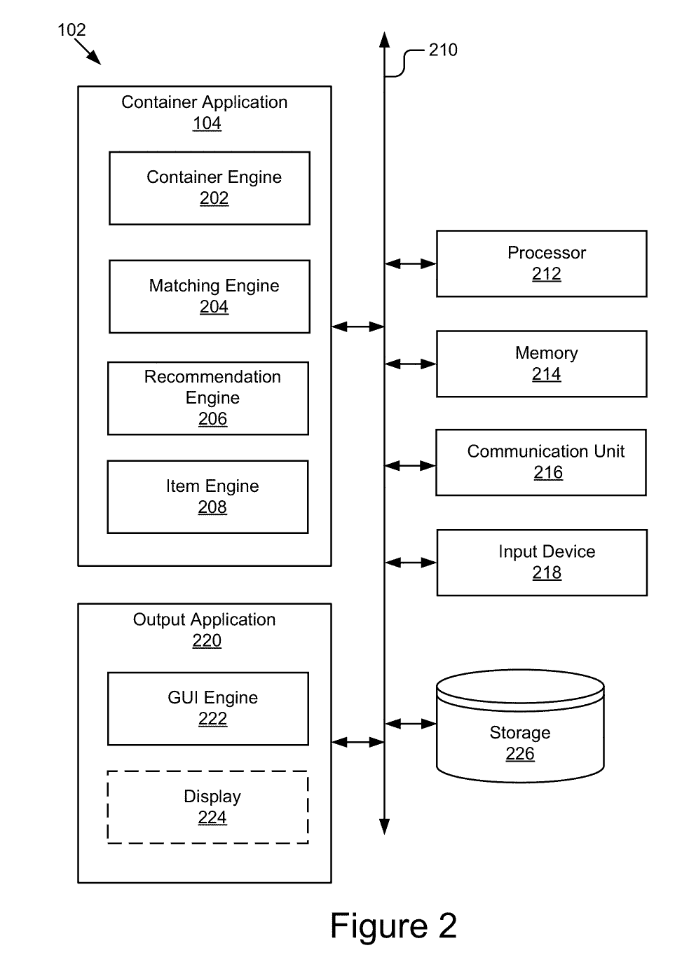

FIG. 2 is a block diagram of an example server 102. As depicted, the server 102 may include container application 104, output application 220, processor 212, memory 214, communication unit 216, and input device 218, which are communicatively coupled by a communications bus 210. However, it should be understood that the server 102 is not limited to such, and may include more, fewer, and/or different elements, including, for example, those discussed with reference to the server 102 in FIG. 1.

The processor 212 may execute software instructions by performing various input/output, logical, and/or mathematical operations. The processor 212 has various computing architectures to process data signals including, for example, a complex instruction set computer (CISC) architecture, a reduced instruction set computer (RISC) architecture, and/or an architecture implementing a combination of instruction sets. The processor 212 may be physical and/or virtual, and may include a single core or plurality of processing units and/or cores.

The memory 214 is a non-transitory computer-readable medium that is configured to store and provide access to data to the other elements of the server 102. In some implementations, the memory 214 may store instructions and/or data that may be executed by the processor 212. For example, the memory 214 may store the container application 104 and/or the output application 220. The memory 214 is also capable of storing other instructions and data, including, for example, an operating system, hardware drivers, other software applications, data, etc. The memory 214 may be coupled to the bus 210 for communication with the processor 212 and the other elements of the server 102.

The communication unit 216 may include one or more interface devices (I/F) for wired and/or wireless connectivity with the network 106 and/or other devices. In some implementations, the communication unit 216 may include transceivers for sending and receiving wireless signals. For instance, the communication unit 216 may include radio transceivers for communication with the network 106 and for communication with nearby devices using close-proximity (e.g., Bluetooth®, NFC, etc.) connectivity. In some implementations, the communication unit 216 may include ports for wired connectivity with other devices. For example, the communication unit 316 may include a CAT-5 interface, Thunderbolt™ interface, FireWire™ interface, USB interface, etc. In some implementations, the communication unit 216 may be configured to receive control signals for communicating information between the container application 104, the output application 220, the database 108, and/or the client 110.

The input device 218 may include any device for inputting information into the server 102. In some implementations, the input device 218 may include one or more peripheral devices. For example, the input device 218 may include a keyboard (e.g., a QWERTY keyboard), a pointing device (e.g., a mouse or touchpad), microphone, a camera, etc.

The container application 104 may include one or more of a container engine 202, matching engine 204, recommendation engine 206, and/or item engine 208. The elements 202, 204, 206, and 208 may be communicatively coupled by the bus 210 and/or the processor 212 to one another and/or the other elements 212, 214, 216, 218, 220, and/or 226 of the server 102. In some implementations, one or more of the elements 202, 204, 206, and 208 are instantiated as sets of instructions executable by the processor 212 to provide their functionality. In some implementations, one or more of the elements 202, 204, 206, and 208 are stored in the memory 214 of the server 102 and are accessible and executable by the processor 212 to provide their functionality. In any of the foregoing implementations, these components 202, 204, 206, and 208 may be adapted for cooperation and communication with the processor 212 and other elements of the server 102.

The container engine 202 may include software and/or logic for generating and managing the content of a virtual container 114. The container engine 202 may be coupled to the communication unit 216 to send and receive control signals related to managing the virtual container 114 to the database 108 and/or the client 110. For example, in one implementation, the container engine 202 may receive control signals from the communication unit 216 indicating that a client 110 is requesting to add one or more items to the virtual container 114 and the container engine 202 may process those control signals and send separate control signals to the database 108 via the communication unit 216 that cause the database 108 to generate the virtual container 114 and/or add information associated with the one or more items to the virtual container 114.

The matching engine 204 may include software and/or logic for matching two or more clients 110 (such as client 110A matching with client 110B). The matching engine 204 may be coupled to the processor 212, memory 214, and/or communication unit 216 to send and receive information to one or more clients 110 associated with a matching of one or more clients 110. For example, responsive to receiving control signals representing a request to match with another client 110, the matching engine 204 may access profile information stored in memory 214 and associated with different clients 110. The matching engine 204 may apply a scoring algorithm using the profile information to match two or more clients 110 based on scoring criteria. The matching engine 204 may then send the match between the two or more clients 110 to another component of the server 102 and/or notify the clients 110 that were matched via the network 106.

The recommendation engine 206 may include software and/or logic for determining and/or providing a recommendation of an item to one or more clients 110. The recommendation engine 206 may be coupled to the processor 212, memory 214, and/or communication unit 216 to send and receive information to one or more clients 110 associated with determining a recommendation of an item for one or more clients 110. For example, the recommendation engine 206 may access profile information stored in memory 214 and associated with one or more clients 110. The recommendation engine 206 may apply a scoring algorithm using the profile information to determine one or more items that may be recommended to a client 110. The recommendation engine 206 may then send the recommendation of the item to the client 110 and/or another client 110 (such as client 110A and 110B) via the network 106.

The item engine 208 may include software and/or logic for performing actions with information associated with a virtual item. The item engine 208 may be coupled to the processor 212, memory 214, and/or communication unit 216 to send and receive information to one or more clients 110 and/or database 108 to manage items. For example, responsive to receiving control signals representing a request to view the contents of a virtual container 114, the item engine 208 may use the information included in the contents of the virtual container 114 to access and provide information related to the items to the client 110.

The output application 220 may include one or more of a GUI engine 222 and/or a display 224. The elements 222 and/or 2224 may be communicatively coupled by the bus 210 and/or the processor 212 to one another and/or the other elements 212, 214, 216, 218, 104, and/or 226 of the server 102. In some implementations, some or all of the elements 222 are instantiated as sets of instructions executable by the processor 212 to provide their functionality. In some implementations, the elements 222 are stored in the memory 214 of the server 102 and are accessible and executable by the processor 212 to provide their functionality. In any of the foregoing implementations, these components 222 and/or 224 may be adapted for cooperation and communication with the processor 212 and other elements of the server 102.

The display 224 may display electronic images and data output by the server 102 for presentation to a user 122. The display 224 may include any conventional display device, monitor or screen, including, for example, an organic light-emitting diode (OLED) display, a liquid crystal display (LCD), etc. In some implementations, the display 224 may be a touch-screen display capable of receiving input from one or more fingers of a user 122. For example, the display may be a capacitive touch-screen display capable of detecting and interpreting multiple points of contact with the display surface. In some implementations, the server 102 may include a graphics adapter (not shown) for rendering and outputting the images and data for presentation on a display. The graphics adapter (not shown) may be a separate processing device including a separate processor and memory (not shown) or may be integrated with the processor 312 and memory 314.

The GUI engine 222 may include logic and/or software for rendering and outputting the images and data for presentation on display 224 and/or sending in the form of control signals via the network 106 to a display of the client 110. In some implementations, the GUI engine 222 may receive and/or process inputs from a client 110. The GUI engine 222 may be coupled to the processor 212, memory 214, and/or communication unit 216 to send and receive information for rending and outputting a GUI to the client 110. For example, responsive to receiving control signals representing a request to view the contents of a virtual container 114, the GUI engine 222 may use the information included in the contents of the virtual container 114 to access and provide information related to the two items to the client 110.

The storage 226 can be a combination of software and/or hardware for storing, structuring, and providing access to data. For example, a database or other storage mechanism can be used to store, organize, and/or access information associated with items, item models (e.g., visualizations of physical items), user profile information, statistics of client interactions, style cards associated with different clients 110, etc., and/or any other information generated, stored, and/or retrieved by the container application 104.

The underlying storage hardware can be in the form of electro-mechanical disks, solid state disks, RAM, memory, etc. In some implementations, the storage 226 may be or instantiated in conjunction with a distributed data store, such as a cloud-based computing and/or data storage system. In some implementations, the storage 226 may include a database management system (DBMS). For example, the DBMS could be a structured query language (SQL) DBMS. For instance, storage 226 may store data in an object-based data store or multi-dimensional tables comprised of rows and columns, and may manipulate, i.e., insert, query, update, and/or delete, data entries stored in the verification data store using programmatic operations (e.g., SQL queries and statements or a similar database manipulation library). Additional characteristics, structure, acts, and functionality of the storage 226 is discussed elsewhere herein.

As noted above, the functionalities of the client 110, database 108, and/or server 102 can be implemented on other computing devices, or can be distributed between multiple computer systems, including within a cloud-based computing environment in which the functionality of the system 100 is provided as a service over a network 106. It is to be understood that although the server 102, database 108, and/or client 110 are illustrated in FIG. 1 as standalone entities, each component of the system 100 represents a collection of functionalities, which can be instantiated as a single or as multiple modules on one or more of the client 110 and/or server 102 as desired. FIG. 2 illustrates a specific embodiment of server 102 instantiated in the form of specific, multiple modules which are located on server 102. In other embodiments, the functionalities of the system 100 are distributed and/or instantiated in other ways.

The modules of the system 100 and/or server 102 can be instantiated (for example as object code or executable images) within the memory 214 (e.g., RAM, ROM, flash memory) of any server 102 and/or client 110, such that when the processor 212 of the server 102 processes a module, the server 102 executes the associated functionality. As used herein, the terms “computer system,” “computer,” “client,” “client computer,” “server,” “server computer” and “computing device” mean one or more computers configured and/or programmed to execute the described functionality. Additionally, program code to implement the functionalities of the system 100 can be stored on computer-readable storage media. Any form of tangible computer readable storage medium can be used in this context, such as magnetic or optical storage media. As used herein, the term “computer readable storage medium” does not mean an electrical signal separate from an underlying physical medium.

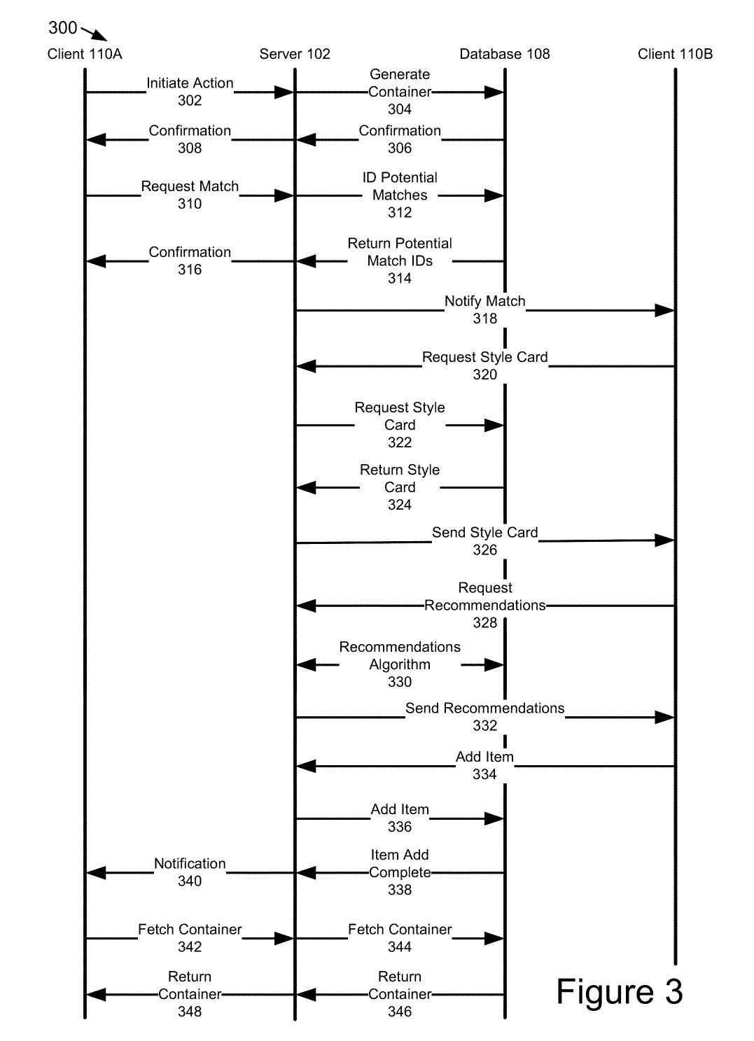

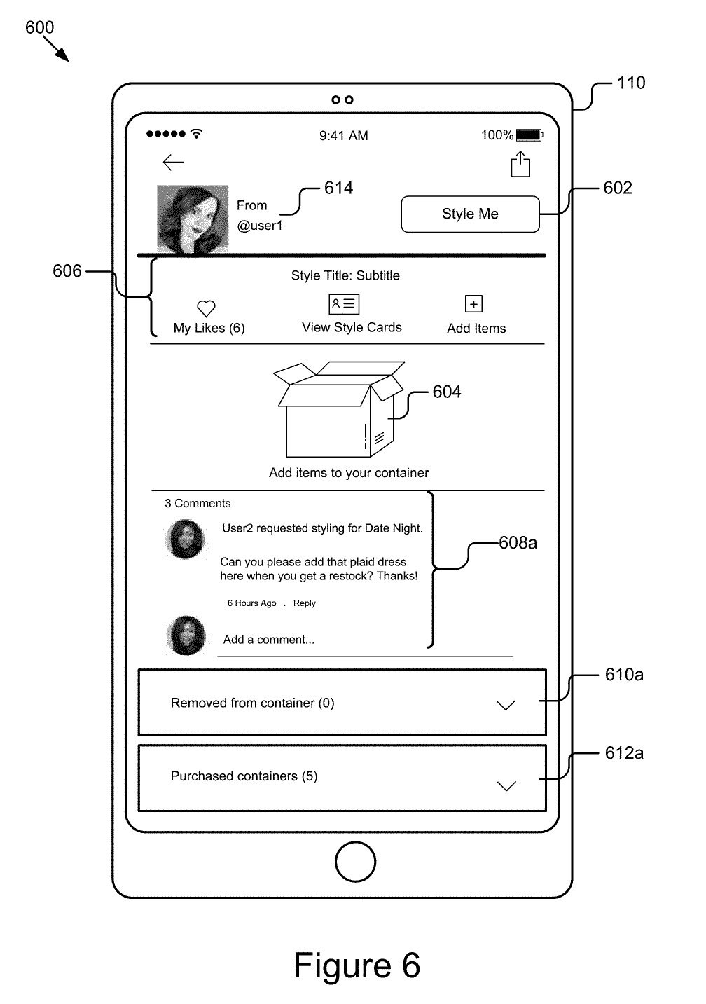

FIG. 3 is a flowchart of an example block diagram 300 illustrating an example method for managing containers according to one implementation. The block diagram 300 illustrates the sources and destinations of control signals between a client 110a, a server 102, database 108, and/or client 110B. In some implementations, client 110a may send control signal 302 to server 102 representing a command to initiate an action. The action may be related to a virtual container 114. For example, the client 110a can receive a request from a user 122a to have other users 122 provide suggestions and items (e.g., to be “styled” by the other users 122 in one example use case discussed below in connection with FIGS. 6-9) and the client 110a can send that request to the server 102 along with any information included in the request, such as a theme for the suggestions and/or items.

Responsive to the server 102 receiving the control signal 302 representing the command to initiate an action, server 102 may send a control signal 304 to the database 108 representing a command to generate a virtual container 114. Responsive to receiving the command to generate the virtual container 114, the database 108 may generate the virtual container 114. In further implementations, the database 108 may associate the generated virtual container 114 with the client 110a that initiated the action, and may grant the client 110a access level permissions to add and/or remove items and/or other content from the virtual container 114. In some implementations, the database 108 may generate the virtual container 114 by allocating a portion of memory to the virtual container 114. For example, the database 108 may store content of the virtual container 114 in an object-based data store, multi-dimensional tables comprised of rows and columns, as a record in a relational database, etc. The database 108 may access and/or manipulate, i.e., insert, query, update, read, write, retrieve, and/or delete, data entries stored in the virtual container 114 using programmatic operations.

Once the virtual container 114 has been generated and is being maintained in the database 108, the database 108 may send a control signal 306 confirming that the virtual container 114 has been generated. Responsive to the server 102 receiving the control signal 306 representing the confirmation from the database 108, the server 102 may send a control signal 308 to the client 110a, confirming to the client that the virtual container 114 has been generated, responsive to the command to initiate an action represented by control signal 302.

A user 122a may interact with the client 110a, and initiate the sending of a control signal 310 to the server 102 that represents a request to be matched by the server 102. In some implementations, the client 110a may send the request to be matched responsive to user 122a interacting with a portion of a GUI that includes a selectable component representing a request to be matched. In some implementations, the client 110a may initiate the request to be matched automatically. For example, the client 110a may determine that a container 114 has been generated and automatically send the control signal 310 requesting the match to the server 102.

Responsive to the server 102 receiving the request to be matched, the matching engine 204 can execute the request to be matched. In some implementations, as part of the match request, the matching engine 204 may send a control signal 312 to the database 108 requesting an identity of one or more potential matches. In some implementations, the matching engine 204 may use one or more attributes received from the client 110a as part of the match request. The one or more attributes received from the client 110a may include information received directly from the client 110a, such as the identity of the client 110a, the identity of a user 122a that is using the client 110a, a specific theme of the request, etc.

In some implementations, the matching engine 204 may also infer attributes from previous behavior of the client 110a. In some implementations, the matching engine 204 may access history of interactions of the previous behavior of the client 110a, as well as directly received attributes from a style card associated with the client 110a. In some implementations, the style card may be a data sheet of attributes associated with the client 110a (or other clients 110), and the style card may be sharable with one or more clients 110 based on permissions from the client 110a. In one example, the style card may include one or more attributes such as brand preference, size preference, color preference, items requested, items searched and/or viewed, events, style preferences, pricing preferences, other clients 110 that the client 110a has previously interacted with (such as liked, purchased from, requested, messaged, viewed previous virtual containers of client 110a, etc.), overall style genome, past interactions between client 110a and other clients 110 (such as client 110b), etc.

In some implementations, the matching engine 204 may identify the potential matches on at the server 102 by using a software model including a scoring algorithm that matches the attributes of client 110a with attributes of a matching client 110 (such as client 110b). In some implementations, the attributes of a matching client 110b may include (along with the previously identified client attributes) a responsiveness of the matching client 110b, past success rate of closing sales using virtual containers 114, past success rate of previous interactions using virtual containers 114, a brand and/or price of items available, and/or a category of items available. The matching engine 204 may compare the attributes of the client 110a with the attributes of the matching client 110b using the scoring algorithm and identify one or more potential clients 110 that satisfy the conditions of the scoring algorithm.

In some implementations, the scoring algorithm may be one form of a matching algorithm. In further implementations, the recommendations algorithm may be another form of a matching algorithm. The scoring algorithm and/or the recommendations algorithm may be independent matching algorithms that operate by matching attributes of clients 110 and/or characteristics of virtual items. In some implementations, the matching algorithm may make connections between the attributes and/or characteristics within graphs using edges that do not share common vertices or may create a bipartite matching, where two subsets of vertices are distinguished and each vertex in one subgroup can be matched to a vertex in another subgroup. Examples of different matching algorithms that can be applied include weighted matching algorithms, unweighted matching algorithms, weighted and/or unweighted bipartite graphs, Blossom algorithms, Hungarian matching algorithms, a Hoperoft-Karp matching algorithm, Ford-Fulkerson matching algorithm, etc.

In some implementations, the matching engine 204 may send the attributes of the client 110a and/or the attributes of the matching clients 110b-110n to the database 108 and the database 108 may execute and apply the scoring algorithm to identify matches and/or matching information. The database 108 may receive the matches and/or matching information and access profiles of the identified clients 110. The database 108 may send a control signal 314 to the server 102 that may include the potential match identifiers of the clients 110 and/or the user 122. Upon receipt of the potential match identifiers, the server 102 may send a control signal 316 to the client 110a that represents a confirmation that the match has been executed and one or more clients 110 have been identified as a result of the match. In some implementations, the server 102 may also send to the client 110a, the identities of the one or more matches along with or instead of the confirmation.

In some implementations, the server 102 may send a control signal 318 to client 110b that represents a notification that client 110b is a match with client 110a. In some implementations, the notification may be a push notification that client 110b may output to notify the user 122b. In some implementations, the notification may be an email and/or newsfeed item. In further implementations, the notification may appear as an alert on a GUI presented on the display 224 of the client 110. In some implementations, more than one client 110 may be a match and the server 102 may send control signals (not shown) to multiple clients 110, such as client 110b and client 110c (not shown).

In some implementations, the notification to the client 110b may include an approval notification that the client 110b may send back to the server 102 responsive to the client 110b approving the notification and matching with the client 110a. In further implementations, if the approval notification is not accepted or a timeout period occurs before the approval notification is accepted, the server 102 may update the matches and notify an additional client 110 (such as client 110c) about the match and send that client 110 an approval notification that allows the client 110 to opt into matching with the client 110a. In further implementations, responsive to receiving approval of the notification, the server 102 may update the permissions of the client 110.

In some implementations, the client 110b may send a control signal 320 to the server 102 requesting one or more attributes concerning client 110a, such as the style card associated with client 110a. Responsive to receiving control signal 320, the server 102 may send control signal 322 to the database 108 requesting the one or more attributes concerning client 110a, such as the style card associated with client 110a. The one or more attributes concerning client 110a may include the attributes concerning client 110a described elsewhere herein. The database 108 may send control signal 324 to the server 102, returning the one or more attributes concerning client 110a, such as the style card associated with client 110a. The server 102 may send control signal 326 to the client 110b, returning the one or more attributes concerning client 110a, such as the style card associated with client 110a. In some implementations, client 110b may use the attributes concerning client 110a to identify one or more virtual items that client 110b may add to the virtual container. For example, if the style card identifies that client 110a prefers a specific brand of shirts, then client 110b may search for only that specific brands of shirts from a plurality of items, and identify one or more of the specific brand of shirts that meet any additional criteria based on attribute of the client 110a (such as sizing, pricing, etc.).

In some implementations, the client 110b may send a control signal 328 to the server 102 requesting a recommendation for one or more items from the plurality of times. Server 102 may send a back and forth control signal 330 to the database 108 to determine one or more recommendations. In some implementations, the recommendation engine 206 on the server 102 may determine the one or more recommendations responsive to receiving the control signal 328 from the client 110b. In further implementations, the recommendation engine 206 may automatically determine the one or more recommendations.

In some implementations, the recommendation engine 206 may use one or more of the attributes of the client 110a to determine one or more recommendations of one or more items. The recommendation engine 206 may receive the attributes of the client 110a such as the style card, and may determine one or more items that match with criteria of the attribute of the client 110a. In some implementations, a recommendations algorithm may be used by the recommendation engine 206 to determine the one or more recommendations by matching the attributes of the client 110a with characteristics of the virtual items. In some implementations, the recommendations algorithm may be use a matching algorithm similar to, but independent from the scoring algorithm for matching clients 110. The recommendations algorithm may be a type of matching algorithm as described elsewhere herein.

In some implementations, the recommendation engine 206 may also receive a plurality of item characteristics from the database 108. The database 108 may store the information associated with the plurality of items in item lists. The information associated with the items may include a description of each item, a virtual representation of each item, metadata associated with the item (such as a timestamp of when the item was added, a client 110 that offered the item, etc.). The recommendation engine 206 may identify the items by mapping similarities between characteristics of the items and the attributes of the client 110a. The characteristics of the items may include item names, item brand, item types, item style, item size, item price, item themes, complementary items, etc. The recommendation engine 206 may identify one or more of the items that map a threshold criteria of characteristics to the attributes of the client 110a. In some implementations, the recommendation engine 206 may identify recommended items by identifying using the mapping similarities one or more virtual items that exceeds a threshold of similarities with the attributes of the client 110a. In some examples, the threshold of similarities may be an amount, such as if there are more than four similarities, the item may be recommended, etc.

In some implementations, the recommendation engine 206 may incorporate a learning algorithm that uses artificial intelligence to map the characteristics of the items to one or more of the attributes of the client 110a. The learning algorithm may mimic and learn patterns over time responsive to recommendations and interactions between the client 110 and one or more of the plurality of items. By using the learning algorithm, the recommendation engine 206 may not always utilize explicit inputs from the client 110 in order to determine one or more items to recommend to the client 110a.

The recommendation engine 206 may determine the recommendations, including information concerning one or more times, and send a control signal 332 from the server 102 to the client 110b. In some implementations, the client 110b may present the recommendations, including the information concerning the one or more items. A user 122b of the client 110b may view one or more of the recommendations in the GUI. The client 110b may receive an indication as an input from the user 122b selecting one or more of the items and the client 110b may send the control signal 334 to the server 102 representing to add the selected item to the virtual container 114.

In some implementations, the server 102 may send a control signal 336 to the database 108 indicating to add the item to the virtual container 114. In some implementations, the database 108 may add information representing the item to the virtual container 114. The information added to the virtual container 114 may be in the form of a so called virtual item corresponding to a physical item the client 110a may gain possession of. For example, the virtual item may represent a given shirt that the client 110a may opt to take possession of (such as by purchasing). In some implementations, the database 108 may send a control signal 338 to the server 102 representing that the information representing the virtual item has been added to the virtual container 114.

In some implementations, the server 102 may send a control signal 340 representing a notification to the client 110a. The notification may be a push notification that is presented on the display 224 of the client 110a. In further implementations, the notification may appear as a graphical representation in a GUI on the client 110a. The client 110a may review the information of the items that have been added to the virtual container. In some implementations, the client 110a may revise the contents of the virtual container 114, such as by sending a control signal (not shown) to the server 102 to add one or more virtual items to the virtual container 114, remove one or more items from the virtual container 114, make an offer on the content of the virtual container 114, request a subset of themed items to the virtual container 114, etc.

In some implementations, the client 110a may send a control signal 342 to the server 102 that represents a request to fetch the virtual container 114. In some implementations, the client 110a may request to fetch the virtual container 114 when the client 110a does not want to further alter the contents of the virtual container 114. In some implementations, the client 110a may request to fetch the virtual container 114 to publish the virtual container 114, such as to a social media feed, etc. In some implementations, the social media feed may display a graphical representation of the contents of the virtual container 114 and clients 110 that have permissions to comment on the social media feed can provide comments related to the contents of the virtual container 114.

The server 102 may send a control signal 344 to the database 108 that represents the request to fetch the virtual container 114. The database 108 may send a control signal 346 to the server 102 representing the virtual container 114 and/or the contents of the virtual container 114. The server 102 may send a control signal 348 to the client 110a representing the virtual container 114 and/or the contents of the virtual container 114. In some implementations, along with sending the control signal 348, the server 102 may manage the state of the virtual container 114 by changing the state of the virtual container 114 to a locked state. In some implementations, the virtual container 114 in the locked state may be read by a plurality of the clients 110, but additional information related to the contents of the virtual container 114 may not be written to the virtual container 114.

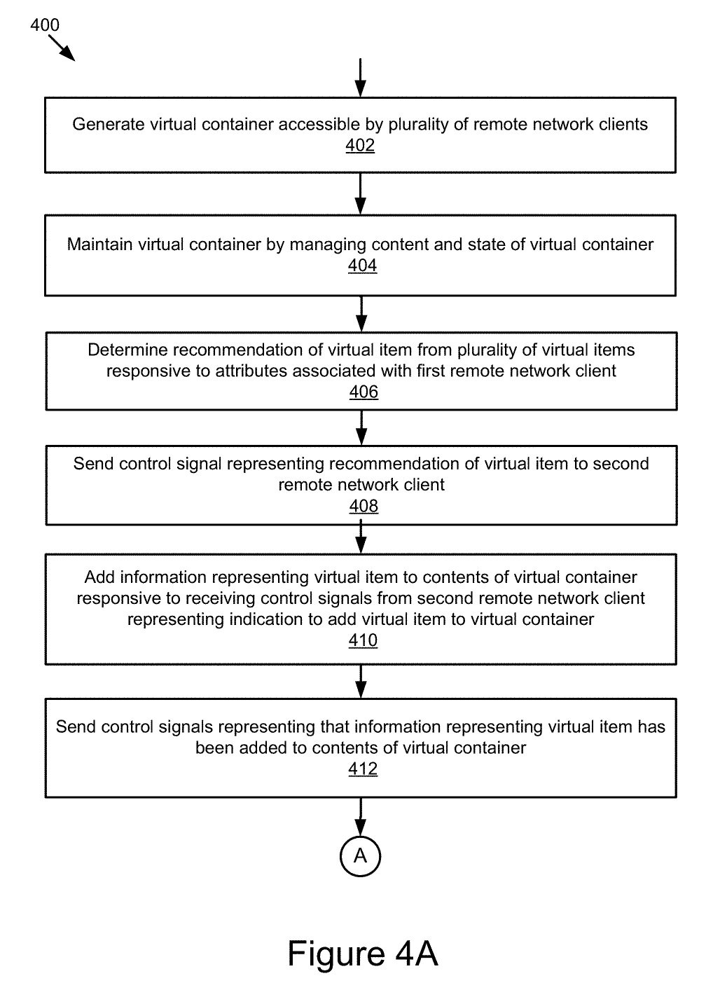

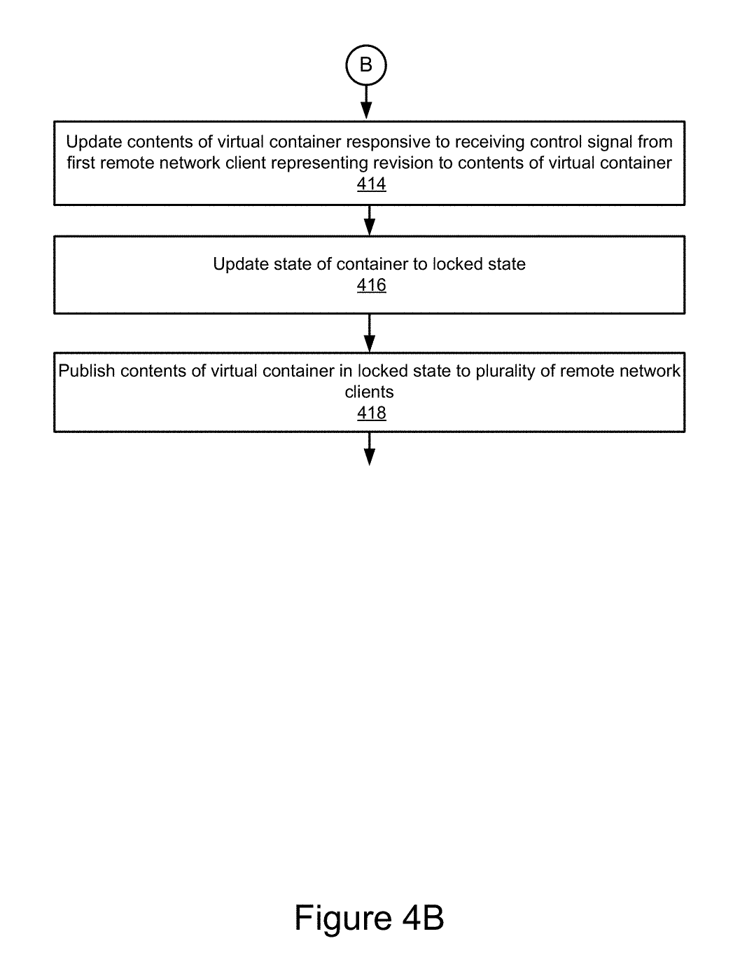

FIGS. 4A and 4B are a flowchart of an example method 400 for managing content of the virtual container 114 according to one implementation. At 402, the container engine 202 may generate a virtual container 114. In some implementations, the virtual container 114 may be accessible by a plurality of clients 110. In some implementations, the clients 110 may be remote network clients that may access the virtual container 114 via the network 106. In some implementations, the virtual container 114 may be a structured virtual representation of a box stored in an area of memory (such as memory 214 or database 108) accessible via the network 106 to the remote network clients 110.

In some implementations, the virtual container 114 may be protected by one or more permissions. The permissions can control access by remote network clients 110 to alter the contents (such as write and/or delete) of the virtual container 114 as desired. The container application 104 may determine which remote network clients 110 have been granted adequate permissions to alter the virtual container 114 and deny requests to clients 110 that have not been granted permissions. In some implementations, the container application 104 may allow only certain remote network clients 110 permission to read the contents of the virtual container 114. In further implementations, the permission to read the contents of the virtual container 114 may be granted to a plurality of remote network clients, while only specific remote network clients (such as client 110a and/or client 110b) are granted permission to write and/or delete content of the virtual container. In some implementations, permissions may be granted responsive to requests from a remote network client 110. In further implementations, the matching engine 204 may grant permissions to write and/or delete content to a specific remote network client 110 that has matched with a given remote network client 110a that has initiated a request to create/maintain a virtual container 114.

At 404, the container engine 202 may maintain the virtual container 114 by managing content of the virtual container 114. Managing the content of the virtual container 114 may include adding, deleting, updating, revising, fetching, publishing, etc., the content of the virtual container 114 responsive to requests from a remote network client 110. In some implementations, container engine 202 may maintain the state of the virtual container 114. The virtual container 114 may have an unlocked state in which content may be written and/or deleted from the virtual container 114. In further implementations the virtual container may have a locked state in which content may only be read out of the virtual container. In some implementations, in the locked state, the container engine 202 may only grant read-only access to one or more of the remote network clients 110 responsive to requests from the remote network clients 110 to view the contents of the virtual container 114.

In some implementations, at 406, the recommendation engine 206 may determine one or more recommendations of virtual items from a plurality of virtual items. In some implementations, the recommendation engine 206 may determine the recommendations responsive to criteria associated with a first remote network client 110a. The virtual items may represent physical items, such as physical items that a user 122b is offering for sale to other users 122 and may be managed by the item engine 208. The user 122b that is offering the physical item for sale may create a virtual item that includes a description of the physical item such as characteristics of the physical item, an image of the physical item, and/or graphical representation of the physical item. In some implementations, the virtual item may be associated with the user 122b and/or the remote network client 110b, and another client 110 may access one or more virtual items associated with remote network client 110b when adding content to the virtual container 114.

In some implementations, the recommendation engine 206 may determine the recommendations of the virtual item using an algorithm to compare the characteristics of the virtual item with one or more attributes concerning the remote network client 110b, as described elsewhere herein. For example, a remote network client 110a may request to be styled for a winter activity, and the recommendation engine 206 may identify that the winter activity includes attributes of cold weather. The recommendation engine 206 may then sort through a plurality of virtual items to only review virtual items that include a characteristic for cold weather. The recommendation engine 206 may perform further comparisons within that sorted list to identify cold weather virtual items that also might match the price range and/or size attributes of the remote network client 110a. The recommendation engine 206 may then perform further comparisons to narrow down the recommendations to an ideal recommendation size (such as one or two complementary virtual items in one implementation). In some implementations, the recommendation engine 206 may also use the matching algorithms to determine the recommendations as described elsewhere herein.

At 408, the recommendation engine 206 may then send a control signal to a second remote network client 110b that the represents the recommended virtual items. In some implementations, the recommendation engine 206 may further send the recommended virtual items to the first remote network client 110a. In some implementations, the second remote network client 110b may review the recommended virtual items and may send a control signal to the server 102 that some of the recommended virtual items should be added to the virtual container 114.

In some implementations, the second remote network client 110b may determine if the recommended virtual items satisfy a condition of the virtual container, such as do the recommend virtual items satisfy a theme and/or style request of the virtual container 114. If the recommended virtual items do not satisfy the condition of the virtual container, then the second remote network client 110b may indicate that those virtual items should not be added to the virtual container 114. In further implementations, the second remote network client 110b may identify one or more additional virtual items that complement the contents of the virtual container 114, and may request to add the complementary virtual items to the virtual container. In some implementations, the recommendation engine 206 may perform the functionality of approving recommended virtual items and/or complementary virtual items automatically using learning algorithms as described elsewhere herein.

At 410, the container engine 202 may add information representing the virtual items to the contents of the virtual container 114 responsive to receiving a control signal from the second remote network client 110b representing an indication to add the virtual item to the virtual container. In some implementations, second remote network client 110b may request to add more than a single virtual item. The second remote network client 110b may further request to add additional complementary virtual items to the contents of the virtual container 114.

At 412, the container engine 202 may cause the information representing the virtual item to be added to the contents of the virtual container 114, and may send a control signal to the first remote network client 110a that the information representing the virtual item has been added to the contents of the virtual container 114. The control signal may include a push notification that the first remote network client 110a may activity present to the user 122a. In further implementations, other types of the notifications are also contemplated and described elsewhere herein. The user 122a of the first remote network client 110a may review the added contents of the virtual container 114.

FIG. 4B continues the flowchart 400 for the example method for managing content of the virtual container according to one implementation. At 414, the container engine 202 may update the contents of the virtual container 114 responsive to receiving a control signal from the first remote network client 110a representing a revision to the contents of the virtual container 114. In some implementations, the first remote network client 110a may revise the contents of the virtual container 114 by adding an additional virtual item, removing a virtual item, requesting a virtual item with a different characteristic (such as a different size or color), etc. By providing both the first remote network client 110a and the second remote network client 110b access (based on permissions) to the virtual container 114 that is generated for the first remote network client 110a, the virtual container 114 can facilitate faster collaboration between the two.

At 416, the container engine 202 may update the state of the virtual container 114 to a locked state. The locked state may prevent additional writing and/or deleting of content as described elsewhere herein. In some implementations, the virtual container 114 may represent a single transactable entity and the contents of the virtual container 114 may represent physical items that are offered for sale to the first remote network client 110a. In this example, the virtual container 114 allows the two remote network clients 110 to proactively negotiate, and virtual items therein may be directly purchased once the state of the virtual container is locked and the contents are sent to a third party application to perform a transaction.

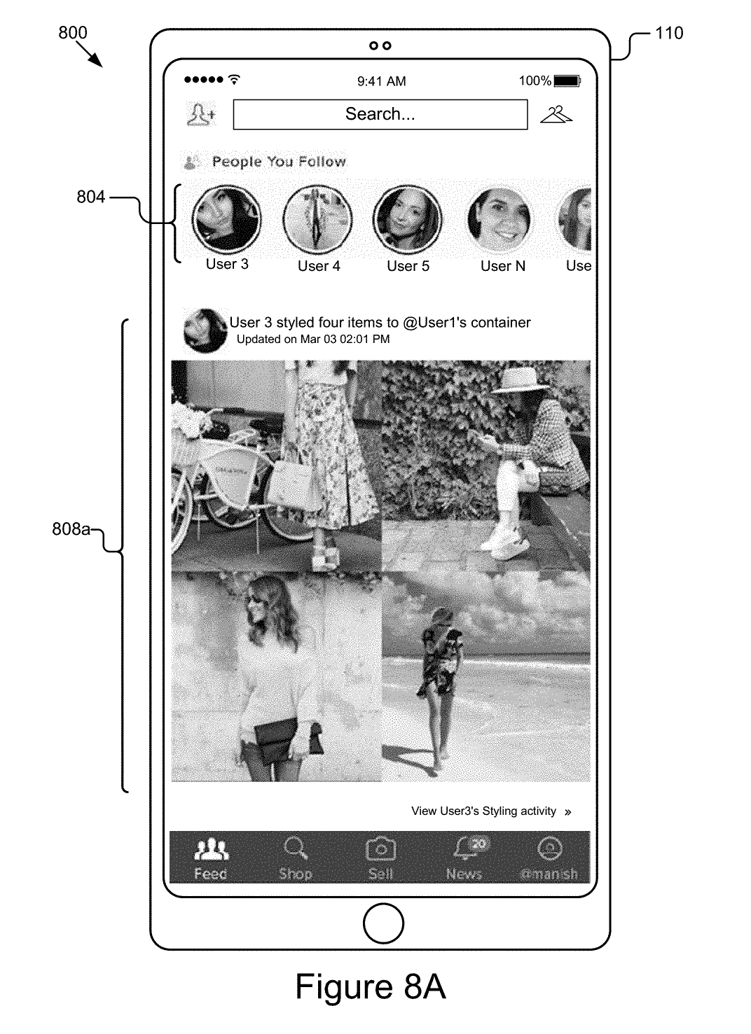

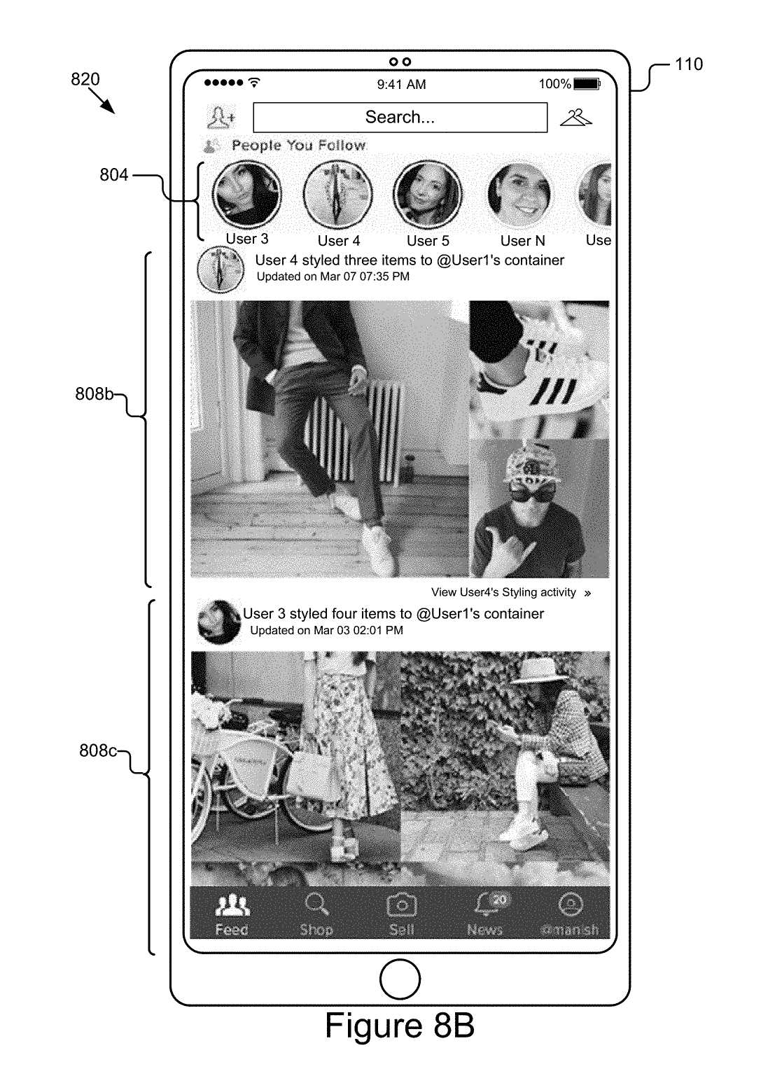

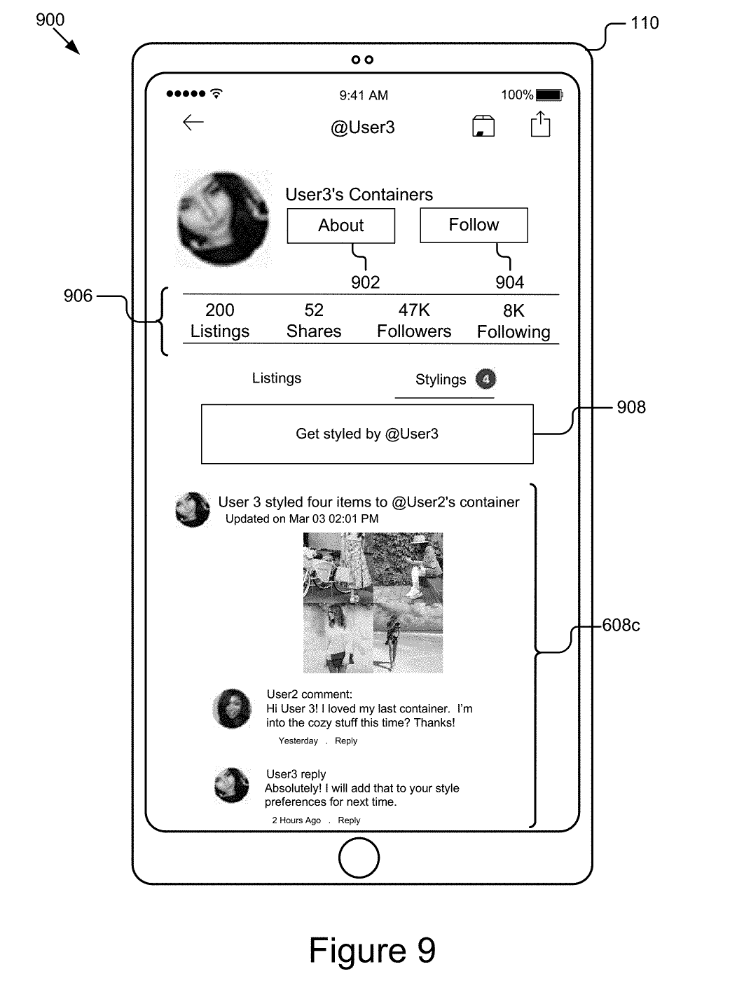

At 418, the output application 220 may publish the contents of the virtual container in the locked state to the plurality of remote network clients 110. In some implementations, publishing the contents of the virtual container includes generating by the GUI engine 222, a GUI that displays graphical representations of the content of the virtual container 114. The graphical representations may be based on item representations received from the item engine 208. The GUI engine 222 may further determine an arrangement of the content of the virtual container 114 based on the amount of content in the virtual container 114. For example, a first layout may be used if two items are in the virtual container 114, while a second layout may be used if four items are in the virtual container 114, as is described in more detail with respect to FIGS. 8A and 8B. The output application 220 may publish the contents of the virtual container by sending, or otherwise making available, the GUI information to one or more of the plurality of remote network clients 110 and displaying the contents of the virtual container within a social media feed, as described in more detail with respect to FIGS. 8 and 9.

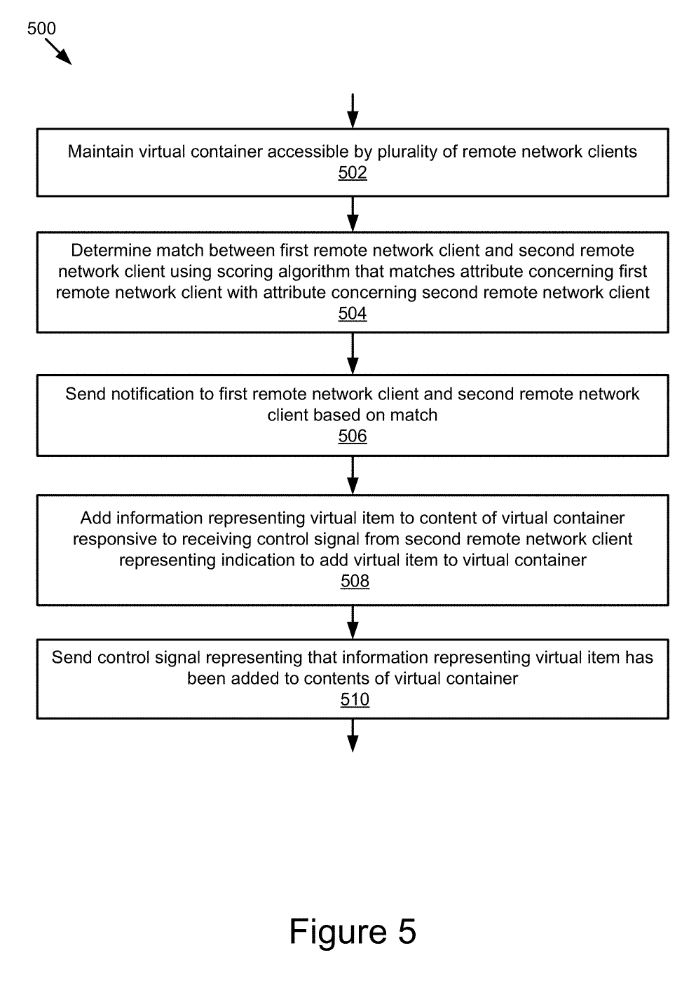

FIG. 5 is a flowchart of an example method 500 for managing content of virtual containers according to one implementation. At 502, the container engine 202 may maintain the virtual container 114 accessible by the plurality of remote network clients 110. As described elsewhere herein, in some implementations, the virtual container 114 may be a structured virtual representation of a box stored in an area of memory accessible via network 106 and protected by permissions. In some implementations, the container engine 202 may maintain the virtual container 114 by managing the contents of the virtual container 114 and/or a state of the virtual container 114.

At 504, the matching engine 204 may determine a match between a first remote network client 110a and a second remote network client 110b. In some implementations, the matching engine 204 may determine the match using a scoring algorithm that matches one or more attribute(s) concerning the first remote network client 110a with one or more attribute(s) concerning the second remote network client 110b as described elsewhere herein.

At 506, the output application 220 may send a notification to the first remote network client 110a and the second remote network client 110b based on the match as described elsewhere herein. For example, if the matching engine 204 determines that in an example, a first remote network client 110a has requested to be styled, the matching engine 204 may compare attributes of client 110a (such as the style card and/or style theme) with attributes of other clients 110, and determine that remote network client 110b includes an attribute that matches (such as based on the style theme). The output application 220 may then send the notification to both remote network clients 110a and 110b to begin styling (e.g., adding virtual items based on the attributes and/or style theme to the virtual container.)

At 508, as described elsewhere herein, the container engine 202 may add information representing the virtual item to content of the virtual container responsive to receiving a control signal from the second remote network client representing an indication to add the virtual item to the virtual container. At 508, the output application 220 may send a control signal representing that the information representing the virtual item has been added to the content of the virtual container 114 as described elsewhere herein.

FIG. 6 is a graphical representation of a graphical user interface 600 for managing content of virtual containers according to one implementation. An example use case for virtual containers is described in conjunction with FIGS. 6-9, in which a user 122a may be a purchaser that requests to be styled by a user 122b and the users 122a and 122b may both add items to the virtual container 114 for the user 122a to purchase. It should be understood that this use case is only one example and other use cases are also contemplated.

In the example, the interface 600 may present profile information 614 concerning a user (e.g., user1), such as a name of the user, a graphical representation of the user, etc. In the example, the interface 600 may present a personal page from which the user (e.g., user1) may initiate a request to be styled, fill a virtual container 114, provide comments to other users (e.g., user2), update a style card, upload information of a virtual item, etc.

In some implementations, the interface 600 may also include an action icon 602. In this example, the action icon 602 may represent a request for the user to be styled by one or more other users of remote network clients 110. In some implementations, the action icon 602 may be a selectable icon that a user may select and activate (e.g., press). Responsive to the selection of the action icon 602, the client 110 may send a control signal to the server 102 requesting the action, such as to style the user of the client 110.

In some implementations, the interface may also include one or more attributes 606 of the client 110, which are described in more detail elsewhere herein. In some implementations the attributes 606 of the client 110 may be associated with the user of the client 110. In the example, the attributes 606 of the client include selectable icons representing the user's likes, the user style cards, and/or an option to add items to a list of items associated with the user. In the example, the user may be a seller of items, and responsive to selecting the add items icon, the user can be presented with an interface that the user can input information into (such as characteristics) of a physical item and the information about the physical item can be stored as a virtual item that represents the physical item.

In the example, a user's likes may including liking other user's profiles, liking other user's individual virtual containers, liking sets of virtual containers, etc. The like's associated with the user may be stored as attributes and used by the recommendation engine 206 and/or matching engine 204 to determine recommendations and/or matches. A user may select the user's likes icon, and be redirected to an interface that displays the user's likes. In some implementations, the interface that displays the user's likes may be interactive, and individual listings may be selected for further viewing, such as selecting a virtual container 114 the user has liked to view the contents of the liked virtual container 114.

In the illustrated example, the container icon 604 is a graphical representation of a box. The container icon 604 represents the virtual container 114. A user may select the container icon 604 to view listings of items that may be selected for adding to the contents of the virtual container 114. In the example, a removed items icon 610 may be presented for selection by a user. Responsive to a selection of the removed items icon 610, the interface may display items that were previously added to the current virtual container 114, but were subsequently removed, such as by client 110 revising the contents of the virtual container 114. In the example, a purchased containers icon 612 may be presented for selection by a user. Responsive to a selection of the purchased containers icon 612, the interface may display the contents of one or more previously purchased virtual containers 114. In some implementations, additional information regarding the previously purchased virtual containers 114, such as metadata related to time of creation, purchase, price, number of days the virtual container 114 has been in a state, amount of shares, most recent themes etc., may also be presented in the interface.

In some implementations, a comment feed 608 may be presented in a portion of the interface. The comment feed 608 may allow other users of the plurality of remote network clients 110 to comment and/or interact directly with the user of the current client 110. In some implementations, other users may write comments in the comment feed 608, such as request for specific items, comments about style choices, themes and/or styles for future virtual containers 114, etc. In some implementations, the user may update the other user's style cards based on the comments in the comments feed 608. In further implementations, the container application 104 may review the contents of the comment feed 608 and automatically identify and store attributes of the plurality of users based on the comments. In the illustrated example, comment feed 608a presents another user inquiring about availability of a physical item for a future virtual container 114.

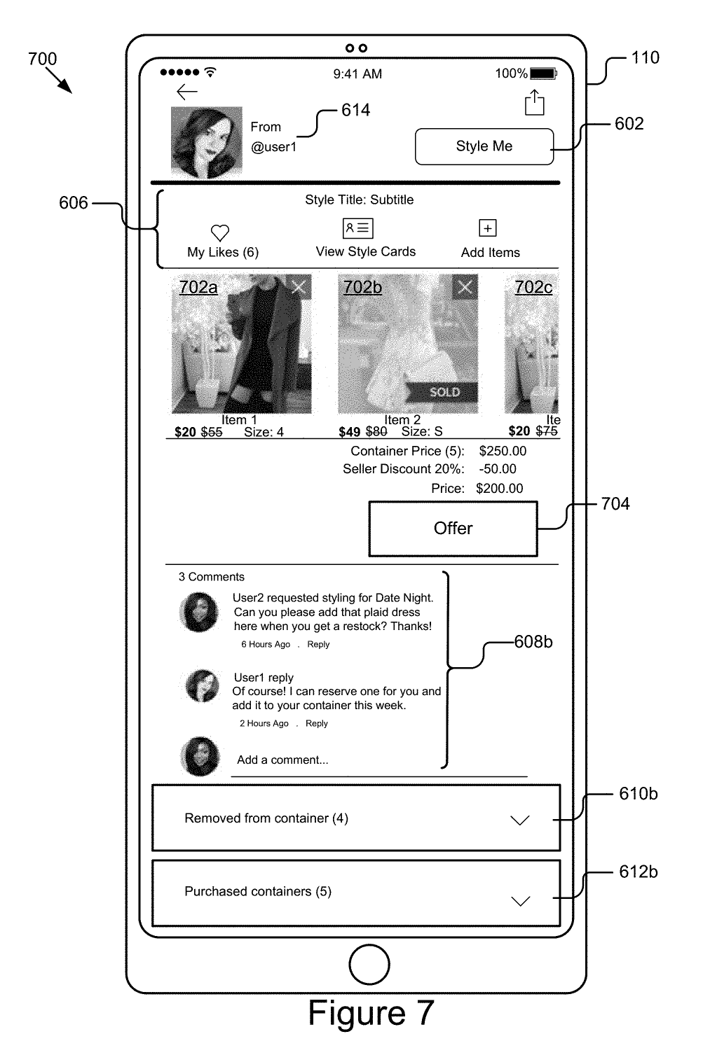

FIG. 7 is a graphical representation of a graphical user interface 700 for managing content of virtual containers 114 according to one implementation. In the example, one or more graphical representations 702 of the virtual items are presented in the interface. The graphical representations 702a, 702b, and/or 702c may be contents of a virtual container 114. In some implementations, the contents of the virtual container 114 may be displayed responsive to a user selecting the container icon 604 (as shown with respect to FIG. 6). The graphical user interface 700 may then display a graphical representation 702 of each physical item (such as an image, etc.) as well as item characteristics, such as cost, size, discounted cost, etc. The virtual items may have been added to the virtual container 114 by the user of the client 110 and/or by other users of other clients 110 as described elsewhere herein. By allowing multiple users (based on permissions of the individual users) to add virtual items to the virtual container 114, the user that initially requested to be styled and receive virtual items in their virtual container can solicit input, feedback, and/or suggestions from other users. This may imitate a styling experience with a personal stylist who provides individualized recommendations on styling choices, while allowing the other user to be remote and interact in real-time. This provides additional convenience while also creating a virtual history of the interactions for future users to review and build on in their styling interactions.

In the example, the interface may include an offer icon 704. Responsive to a user selecting the offer icon 704, the user (which may be a buyer in this instance) may provide an offer to another user (which may be the seller that uploaded the information concerning the virtual items and/or has possession of the physical items represented by the virtual items). The two users may then communicate back and forth to negotiate a price for the contents of the virtual container 114. In some implementations, the seller may be incentivized to provide a discount on specific virtual items if the entire contents of the virtual container 114 are purchased (such as because the shipping may be bundled, etc.), while other examples of offering different prices are also contemplated. The offer icon 704 may allow the two users to interact directly within the framework of the interface. Responsive to an offer being accepted, the container engine 202 may update the state of the virtual container 114 to a locked state, and pass the contents of the virtual container as a data object to a third party transaction application to process for payment and/or to ship the relevant physical items (e.g., the contents of the virtual container.) By combining the steps of adding a virtual item to the virtual container 114 and then purchasing physical items represented by the contents of the virtual container 114, the steps of adding and purchasing can be combined into direct interactions with the virtual container 114 and reduce the amount of steps or actions between adding and purchasing content.

In the illustrated example, the comment feed 608b displays an additional update of another user responding to the inquiry about the availability of an item. In the example, a user1 (representing a seller) responds to the request from the user1 (representing a buyer) about the plaid dress, and the user 2 (representing the seller) agrees to add information representing the plaid dress to the virtual container of user1 (representing the buyer) when the plaid dress becomes available. In some implementations, the item engine 208 may track the movement of virtual items in and out of virtual containers, and update one or more availability statuses responsive to the virtual items being placed in virtual containers, the state of the virtual container being locked, and/or physical items being purchased represented by the virtual items. For example, the graphical representation 702b of the virtual item displays an availability of being “sold”, which may signal to a user that the virtual item 702 is unavailable. In such a situation, a user may interact with the unavailable virtual item and may update their attributes, such as a style card, to request the virtual item when it is available.

FIG. 8A is a graphical representation of a graphical user interface 800 for managing content of virtual containers according to one implementation. In the example, a graphical representation 808a of the contents of a virtual container 114 is presented. In some implementations, the graphical representation 808a may be sent to a requesting client 110 to read and present the contents of the virtual container 114. In some implementations, the requesting client 110 may have to be granted permissions to read the contents of a virtual container. In further implementations, a virtual container in a locked state may be requested to be made available to be read by a plurality of clients 110 (e.g., the clients 110 are given read-only permissions). As shown in the example, the graphical representation 808a presents four virtual items that user3 added to a virtual container 114 associated with user1. In some implementations, the GUI engine 222 may determine an arrangement of the contents of the virtual container 114 based on rules associated with the amount of virtual items included in the contents. Different arrangements may be determined and arranged based on the number of virtual items available, screen space, desired look and feel, etc.

FIG. 8B is a graphical representation of a graphical user interface 820 for managing content of virtual containers according to one implementation. In the example, additional graphical representations 808 are presented, such as graphical representation 808b that includes an arrangement of three virtual items included in a virtual container 114. In another example, graphical representation 808c includes an arrangement of two virtual items included in a virtual container 114.

In the example, the interface may include a listing of various users from the plurality of clients 110. One or more user icons 804 may be displayed in the interface, and responsive to a user selecting a user icon 804, the interface may present a social feed presenting the history of interactions with virtual containers 114 by the selected user.

FIG. 9 is a graphical representation of a graphical user interface 900 for managing content of virtual containers according to one implementation. In the example, a profile of a user is presented. The interface displaying the profile of the user may include an about icon 902 that another user may select to learn more about the presented user. Selecting the about icon 902 may present one or more of the attribute associated with the presented user as described elsewhere herein. The interface may also include a follow icon 904. Responsive to another user selecting the follow icon, the GUI engine 222 may populate the other users social feed with intermittent statuses based on interactions with virtual containers 114 by the presented user.

The interface may also include a history interface 906 that presents information related to actions the presented user has performed. The actions may include an amount of virtual items that have been listed (both historically and/or currently available), an amount of graphical representations that have been shared (such as the published contents of a virtual container that has been shared to another user's social feed), the number of other users following the actions of the presented user, and/or the number of other users that the presented user is following.

The interface may also include a personal styling icon 908. Responsive to another user selecting the personal styling icon 908, the server 102 may send a notification to the remote network client 110 associated with the presented user. The presented user may be granted permission to add one or more virtual items to a virtual container associated with the user that selected the personal styling icon 908. The interface may also include a comments feed 608c as described elsewhere herein. In this example, the comments feed 608c shows the presented user responding to a request related to an updated theme (for example, “cozy stuff”) for a future virtual container 114.

In the specific example described above, managing the contents of the virtual container 114 allows for a social two-way interaction to occur between a client 110a (representing a buyer) and a client 110b (representing a stylist providing recommendations of items). The two-way interaction may emulate a face-to-face styling conversation between a customer and stylist, but instead be performed over disparate distances using the remote network clients 110 and the server 102 to guide the interaction between two remote network clients. The server 102 may use advanced algorithms (such as the recommendation engine 206 and/or the matching engine 204) to match a client 110a to a client 110b for styling and provide recommendations of virtual items for the stylist to review. The two-way interaction with the server 102 providing back-end support is more than merely a conversation between two remote clients 110, but instead is a guided and structured interaction where both clients 110 may manage the contents of the virtual container 114 and the virtual container 114 is being controlled by more than just the client 110 that is offering virtual items for viewing and/or purchase (e.g., a seller).

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including magnetic disks, solid state disks, optical disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations combining such elements. For instance, the technology may be implemented in software, which can further include but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently tied to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in other ways. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method, for providing multiple users with access to a virtual container, the method comprising the steps of:
generating by a server, a virtual container accessible by a plurality of remote network clients, wherein the virtual container is a structured virtual representation of a box stored in an area of memory accessible via a network and protected by permissions;
maintaining the virtual container, wherein maintaining the virtual container comprises managing contents of the virtual container and managing a state of the virtual container;
determining a recommendation of a virtual item from a plurality of virtual items responsive to one or more attributes associated with a first remote network client of the plurality of remote network clients;
sending over the network to a second remote network client of the plurality of remote network clients, a control signal representing the recommendation of the virtual item;
adding information representing the virtual item to the contents of the virtual container responsive to receiving a control signal over the network from the second remote network client representing an indication to add the virtual item to the virtual container;
sending over the network to the first remote network client, a control signal representing that the information representing the virtual item has been added to the contents of the virtual container;
updating the contents of the virtual container responsive to receiving a control signal over the network from the first remote network client representing a revision to the contents of the virtual container;
updating the state of the virtual container to a locked state; and
publishing the contents of the virtual container in the locked state to the plurality of remote network clients.

2. The method of claim 1, wherein publishing the contents of the virtual container in the locked state further comprises:
granting read-only access to the contents of the virtual container for one or more of the plurality of remote network responsive to receiving a control signal over the network from the one or more of the plurality of remote network clients requesting to read the contents of the virtual container.

3. The method of claim 1, further comprising:
directing a third party server to take further action responsive to the virtual container being updated to the locked state.

4. The method of claim 1, further comprising:
generating the virtual container by the server responsive to receiving a control signal over the network from the first remote network client representing a request for virtual items to be added to the virtual container.

5. The method of claim 1, further comprising:
determining by the server, a match between the first remote network client and the second remote network client, the match being determined using a scoring algorithm that matches at least one attribute concerning the first remote network client with at least one attribute concerning the second remote network client; and
sending notifications to the first remote network client and the second remote network client responsive to the match.

6. The method of claim 5, wherein the attribute concerning the first remote network client comprises profile information associated with a user of the first remote network client and the attribute concerning the second remote network client includes one or more of a responsiveness of the second remote network client, a type of physical item available from the second remote network client, and a success rate of previous interactions of the second remote network client.

7. The method of claim 1, wherein determining the recommendation of the virtual item further comprises:
comparing the one or more attributes associated with the first remote network client with item characteristics associated with the plurality of virtual items; and
identifying the virtual item that exceeds a threshold of similarities with the one or more attributes of the first remote network client, responsive to the comparison.

8. The method of claim 1, wherein updating the contents of the virtual container further comprises one of adding information representing an additional virtual item and removing information representing a previously added virtual item from the contents of the virtual container.

9. The method of claim 1, wherein publishing the contents of the virtual container further comprises:
generating a graphical user interface that displays a graphical representations of the contents of the virtual container; and
sending the graphical user interface over the network to a remote network client of the plurality of remote network clients responsive to receiving a control signal over the network from the remote network client representing a request to view the contents of the virtual container.

10. A computer-implemented method, for providing multiple users with access to a virtual container, the method comprising the steps of:
maintaining by a server, a virtual container accessible by a plurality of remote network clients, wherein the virtual container is a structured virtual representation of a box stored in an area of memory accessible via a network and protected by permissions and wherein maintaining the virtual container comprises managing contents of the virtual container and managing a state of the virtual container;
determining by the server, a match between a first remote network client and a second remote network client, the match being determined using a scoring algorithm that matches at least one attribute concerning the first remote network client with at least one attribute concerning the second remote network client;
sending a notification to the first remote network client and a notification to the second remote network client responsive to the match;
adding information representing a virtual item to the contents of the virtual container responsive to receiving a control signal over the network from the second remote network client representing an indication to add the virtual item to the virtual container; and
sending over the network to the first remote network client, a control signal representing that the information representing the virtual item has been added to the contents of the virtual container.

11. The method of claim 10, wherein the attribute concerning the second remote network client includes one or more of a responsiveness of the second remote network client, a type of physical item available from the second remote network client, and a success rate of previous interactions of the second remote network client.

12. The method of claim 10, wherein the attribute concerning the first remote network client comprises profile information associated with a user of the first remote network client.

13. The method of claim 10, wherein the information is first information and the virtual item is a first virtual item, the method further comprising:
adding second information representing a second virtual item to the contents of the virtual container responsive to receiving a control signal over the network from the first remote network client representing an indication to add the second virtual item to the virtual container.

14. The method of claim 13, further comprising:
updating the state of the virtual container to a locked state responsive to receiving a control signal over the network from the first remote network client representing a request to lock the virtual container; and
publishing the contents of the virtual container in the locked state to the plurality of remote network clients.

15. The method of claim 14, wherein publishing the contents of the virtual container further comprises:
generating a graphical user interface that displays a graphical representations of the contents of the virtual container; and
sending the graphical user interface over the network to a remote network client of the plurality of remote network clients responsive to receiving a control signal over the network from the remote network client representing a request to view the contents of the virtual container.

16. The method of claim 14, wherein publishing the contents of the virtual container in the locked state further comprises:
granting read only access for one or more of the plurality of remote network clients responsive to receiving a control signal over the network from the one or more of the plurality of remote network clients requesting to read the contents of the virtual container.

17. The method of claim 14, further comprising:
directing a third party server to take further action responsive to the virtual container being updated to the locked state.

18. A server that maintains a virtual container accessible by a plurality of remote network clients, comprising:
a processor; and
a memory comprising:
a first component to generate and maintain a virtual container accessible by a plurality of remote network clients, wherein the virtual container is a structured virtual representation of a box stored in an area of memory accessible via a network and protected by permissions and wherein maintaining the virtual container comprises managing contents of the virtual container and managing a state of the virtual container;
a second component to determine a match between a first remote network client of the plurality of remote network clients and a second remote network client of the plurality of remote network clients, the match being determined using a scoring algorithm that matches at least one attribute concerning the first remote network client with at least one attribute concerning the second remote network client;
a third component to determine a recommendation of a virtual item from a plurality of virtual items responsive to one or more criteria associated with the first remote network client;
a fourth component to add information representing the virtual item to the contents of the virtual container responsive to receiving a control signal over the network from the second remote network client representing an indication to add the virtual item to the virtual container and update the contents of the virtual container responsive to receiving a control signal over the network from the first remote network client representing a revision to the contents of the virtual container;
wherein the first component updates the state of the virtual container to a locked state responsive to receiving a control signal over the network from the first remote network client to lock the virtual container; and
a fifth component to publish the contents of the virtual container in the locked state to the plurality of remote network clients.

19. The server of claim 18, wherein the information is first information, the virtual item is a first virtual item, and the fourth component is further configured to add second information representing a second virtual item to the contents of the virtual container responsive to receiving a control signal over the network from the first remote network client representing an indication to add the second virtual item to the virtual container.

20. The server of claim 19, wherein the fifth component is further configured to generate a graphical user interface that displays a graphical representation of the first virtual item and a second virtual representation of the second virtual item of the contents of the virtual container and sends the graphical user interface over the network to a remote network client of the plurality of remote network clients responsive to receiving a control signal over the network from the remote network client representing a request to view the contents of the virtual container.
